(19) United States
(12) Patent Application Publication
(10) Pub. No.: US 2009/0308212 A1
(43) Pub. Date: Dec. 17, 2009

(54) DUAL LOCK SYSTEM FOR A HAND TOOL

(75) Inventor: Hector R. Hernandez, Fullerton, CA (US)

Correspondence Address: STEPTOE & JOHNSON LLP, 2121 AVENUE OF THE STARS, SUITE 2800, LOS ANGELES, CA, 90067, US

(73) Assignee: ALLTRADE TOOLS LLC, Long Beach, CA (US)

(21) Appl. No.: 12/138,270

(22) Filed: Jun. 12, 2008

(51) Int. Cl. B25B 33/00

(52) U.S. Cl. 81/488

(57) ABSTRACT

A dual locking system for a tool including a first actuator and a second actuator each of which are required to be actuated to unlock the tool. The system includes spring biased locking members individually and operatively associated with a button assembly.

### BACKGROUND

The present disclosure is directed towards a locking system, and more particularly, to a hand tool including a locking system for multiple folding tools.

Multi-functioning tools have been developed and are readily available to the individual. Various of the tools include retractable or foldable pliers halves each attached to one handle of a pair of pivots handles. The handles, in turn, include channels for foldably receiving other tools such as knives, files and scissors.

Moreover, various approaches have been taken to secure folding tools within handles of such multi-function hand tools. There is utility in locking tool blades within handles forming a multi-function tool as well as locking tool blades in extended configurations. Several approaches to locking folding tools have been developed. A single lock or a single actuator mechanism has been employed to secure tools in closed or open positions. However, such approaches are limiting as tools can be inadvertently locked or unlocked through the actuation of a lock mechanism or other manipulation of the hand tool.

Accordingly, what is needed is a hand tool including a dual lock arrangement. The present disclosure satisfies these and other needs.

### SUMMARY

Briefly and in general terms, the present disclosure is directed towards a dual lock system. In one aspect, the dual lock system is included in a hand tool.

In one embodiment, the dual lock system includes first and second individually actuatable locking members. Each locking member is actuated by a separate actuator. In a preferred approach, the locking members are spring biased.

In one particular embodiment, the dual lock system includes a pair of button assemblies held by a collar. Each button assembly includes a button and a post with ramped surfaces formed thereon. The ramped surfaces of the posts engage projections extending from an underside of a spring biased locking member. In one approach, the locking members are biased by an extension spring. Actuation of a first button assembly permits the extension spring to draw one locking member inwardly. Subsequent actuation of a second button assembly permits the extension spring to draw a second locking member inwardly. When the locking members are drawing inwardly, tools configured about the dual locking mechanism can be moved between open and closed positions. Releasing the buttons facilitate configuring the locking member back into their outward positions to thereby again lock tools in either open or closed positions.

Moreover, in one approach, the dual locking system is configured to releasably lock tool blades of a multi-function tool in open or closed positions. Each tool blade can embody an opening configured with recesses spaced to receive locking members of a dual locking system. When engaged in the recesses, the locking members lock the tool blades in place.

Other features and advantages of the present invention will become apparent from the following detailed description, taken in conjunction with the accompanying drawings, which illustrate, by way of example, the principles of the invention.

### BRIEF DESCRIPTION OF THE DRAWING

FIG. 1 is a perspective view, depicting a tool including a dual lock system;

FIG. 2 is a top view, depicting the tool of FIG. 1;

FIG. 3 is a side view, depicting the tool of FIG. 1;

FIG. 4 is a front end view, depicting the hand tool of FIG. 1;

FIG. 5 is a back end view, depicting the tool of FIG. 1;

FIG. 6 is a side view, depicting the tool of FIG. 1 in an open configuration;

FIG. 7 is a back end view, depicting the tool of FIG. 6;

FIG. 8 is a front end view, depicting the tool of FIG. 6;

FIG. 9 is a perspective view, depicting the tool of FIG. 6;

FIG. 10 is a rotated perspective view, depicting the tool of FIG. 9;

FIG. 11 is a front view, depicting the tool of FIG. 9;

FIG. 12 is a side view, depicting the tool of FIG. 9;

FIG. 13 is a perspective view, depicting one half of the tool of FIG. 9;

FIG. 14 is a perspective view, depicting the tool of FIG. 9 with tool blades in an open configuration;

FIG. 15 is a perspective view partially in cross-section, depicting one tool of the device of FIG. 14;

FIG. 16 is a perspective view in partial cross-section, depicting another tool of the device of FIG. 14;

FIG. 17 is a partial cross-sectional view, depicting a dual lock mechanism;

FIG. 18 is a partial cross-sectional view, depicting the dual lock system of FIG. 17 with one actuator depressed;

FIG. 19 is a partial cross-sectional view, depicting the system of FIG. 17 with both actuators depressed; and

FIG. 20 is a partial cross-sectional, depicting structure biasing button assemblies of the locking system.

### DETAILED DESCRIPTION

Turning now to the drawings, which are provided by way of example and not limitation, the present disclosure is directed towards a dual locking system. In one approach, the dual locking system is configured in a hand tool such as a multi-function tool.

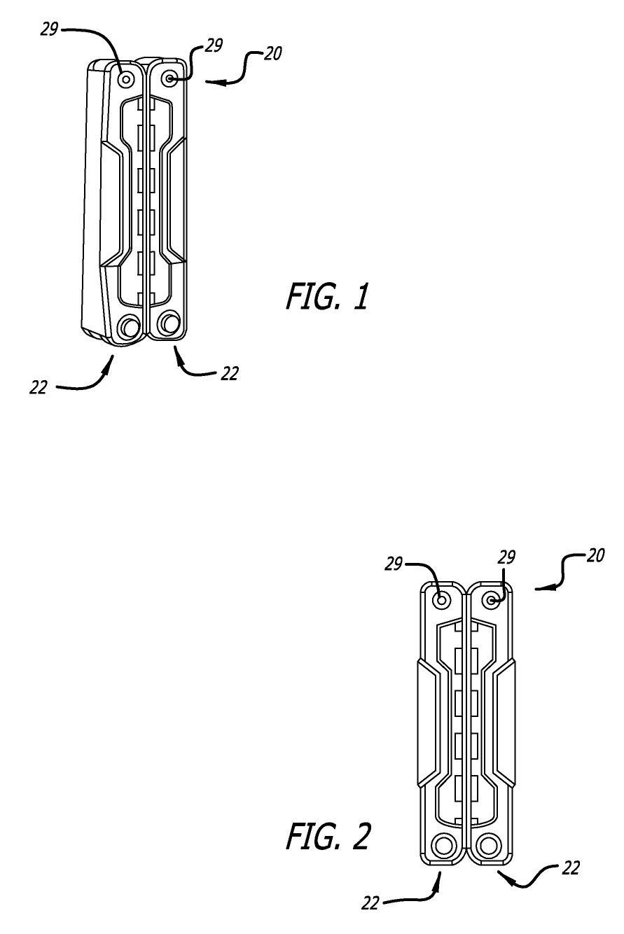

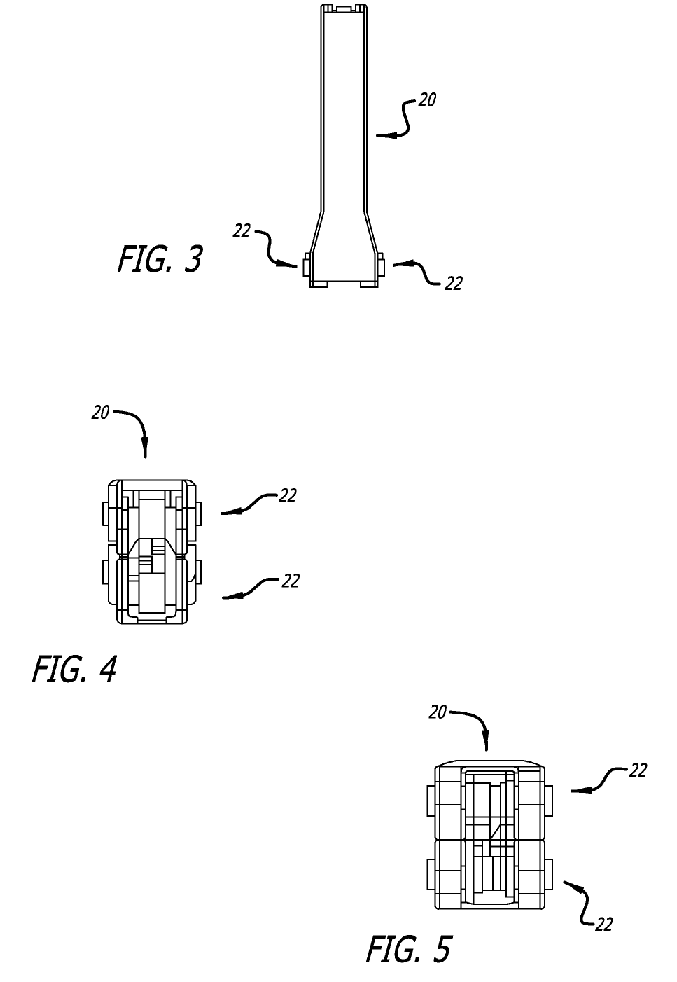

As shown in FIGS. 1-5, a tool 20 can include a dual locking system 22. The tool 20 depicted in FIGS. 1-5 is shown in a closed configuration. Further, the tool 20 includes two dual locking systems 22 configured at one end of the tool 20.

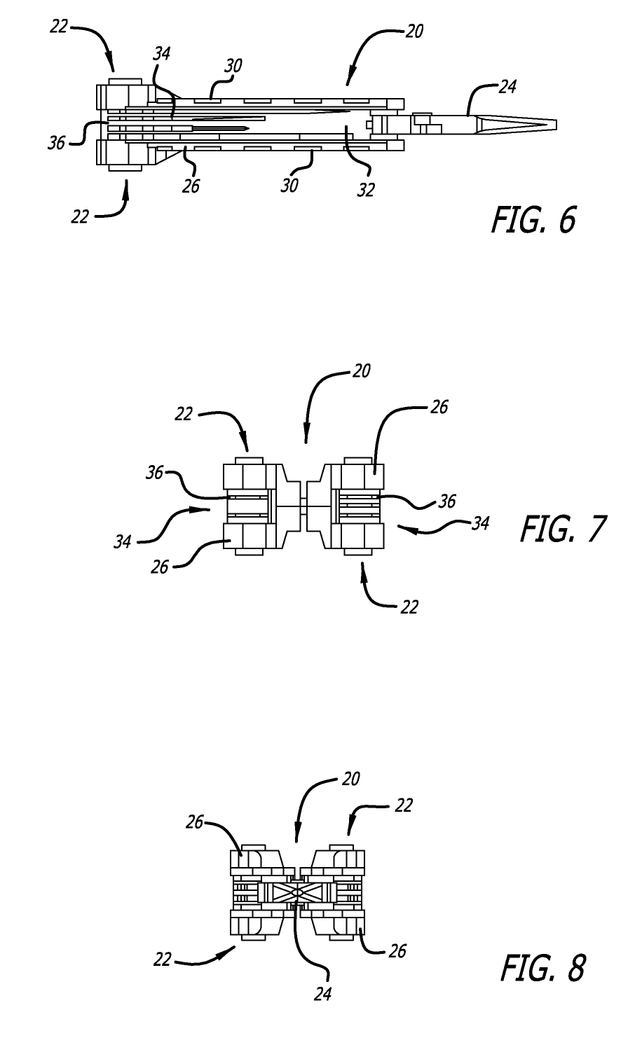

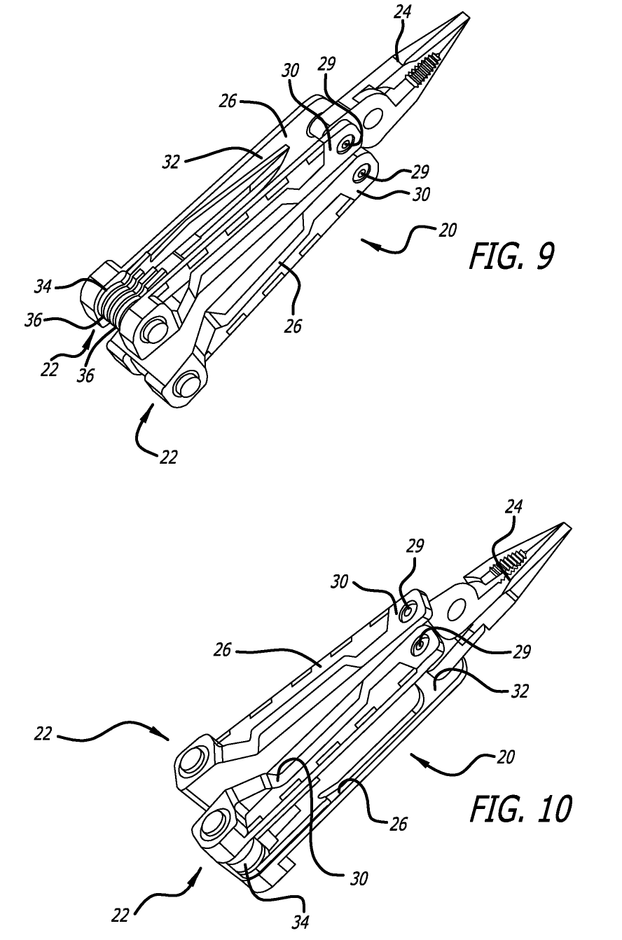

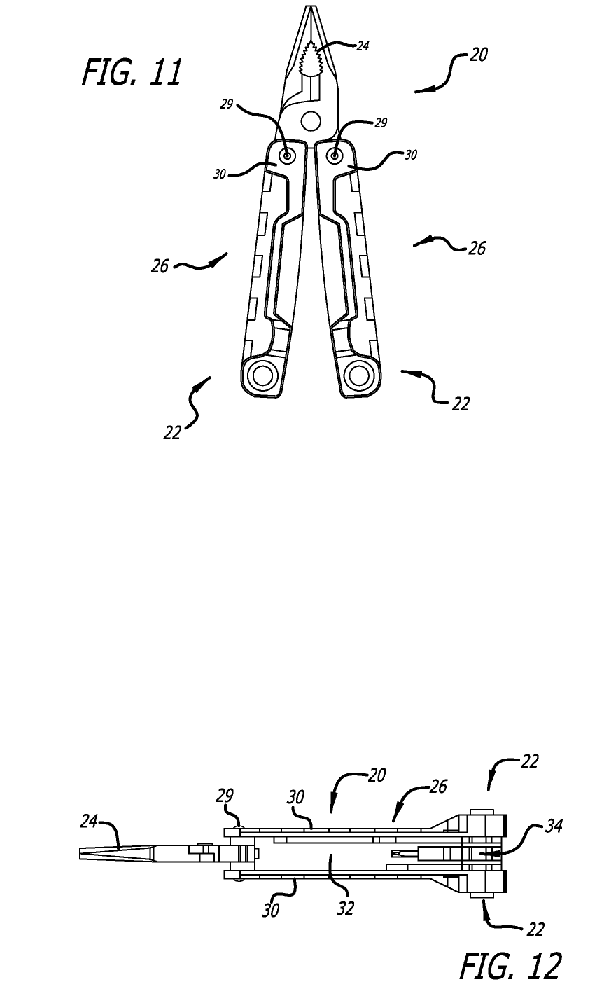

In one embodiment, as shown in FIGS. 6-12, the tool 20 can include retractable pliers 24. The pliers 24 include plier halves, each of which is rotatably connected to one of two handle assemblies 26. The handle assemblies 26 include outer covers 30 attached to members forming a frame 32. The frame 32 is sized and shaped to receive a plurality of tool blades 34. Configured between adjacent blades 34 are spacers 36. The end of the tool including the dual locking system 22 is enlarged with respect to the end of the tool to which the pliers 24 are attached.

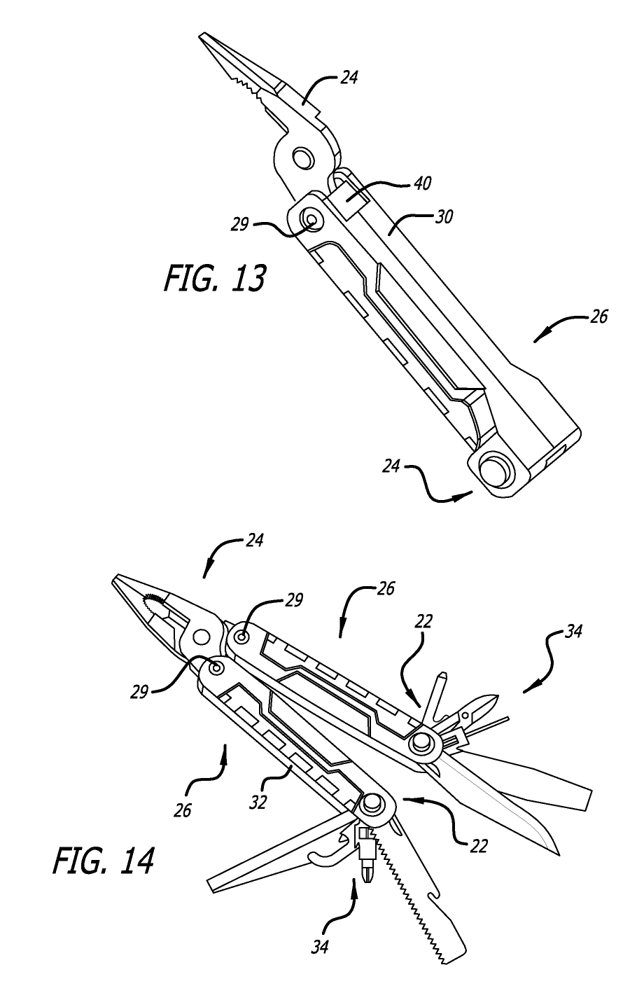

With reference now to FIG. 13, there is shown a single handle 26. The plier half 24 is rotatably connected to the handle assembly 26 at the connection point 29. Control of the rotation of the plier half 24 with respect to the handle assembly 26 is provided by engagement between a solid wall 40 of the inner channel and a portion of the plier half. In this way, the plier 24 can be held in an open or closed position.

As shown in FIG. 14, the tool 20 can include a plurality of tools 34 which are rotatably connected to an end of the handle assembly 26. As stated, the frame 32 is sized and shaped to receive the tools 34. It is also to be recognized that the frame 32 is configured to likewise receive a plier half 24 when the device is placed in its closed position (See FIGS. 1-5).

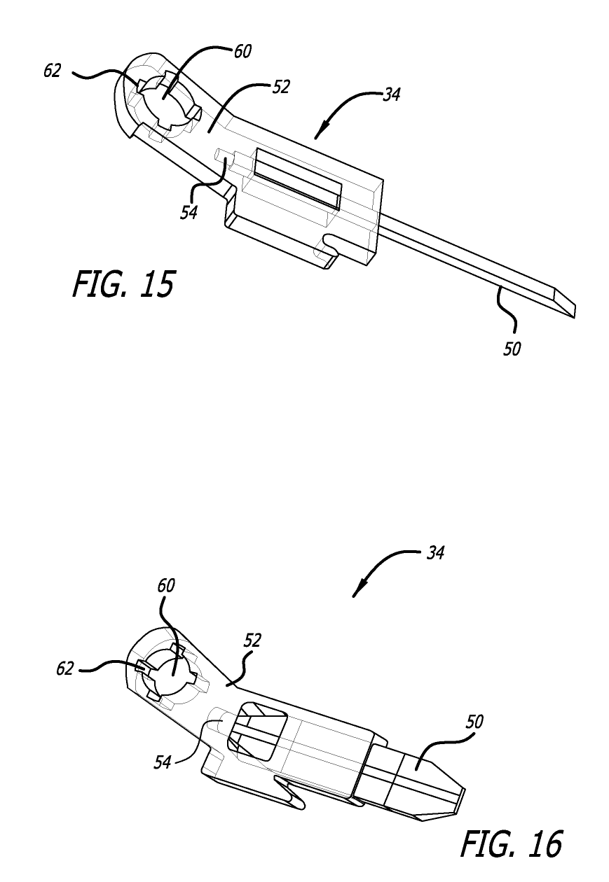

Various tools can be configured to be received within the frame 32 of the handle assembly 26. That is, one or more of scissors, screwdrivers, screws, can openers, knife blades and files can be rotatably attached to a handle assembly 26. As shown in FIGS. 15 and 16, both flat head and Philips screw driver shafts 50 can be replaceably held within a receiver 52 by a magnet 54. The receiver 52 includes one end configured with a through hole 60 including circumferentially spaced recesses 62 sized and positioned to lockingly receive a locking member of the above introduced dual locking system. The through hole 60 is configured to receive an axle (not shown) about which the tool 34 can rotate. At certain degrees of rotation, the tool 34 can be locked at open or closed positions. Such structure can be formed in each of the folding tools so that they too can be locked and unlocked by the dual locking system.

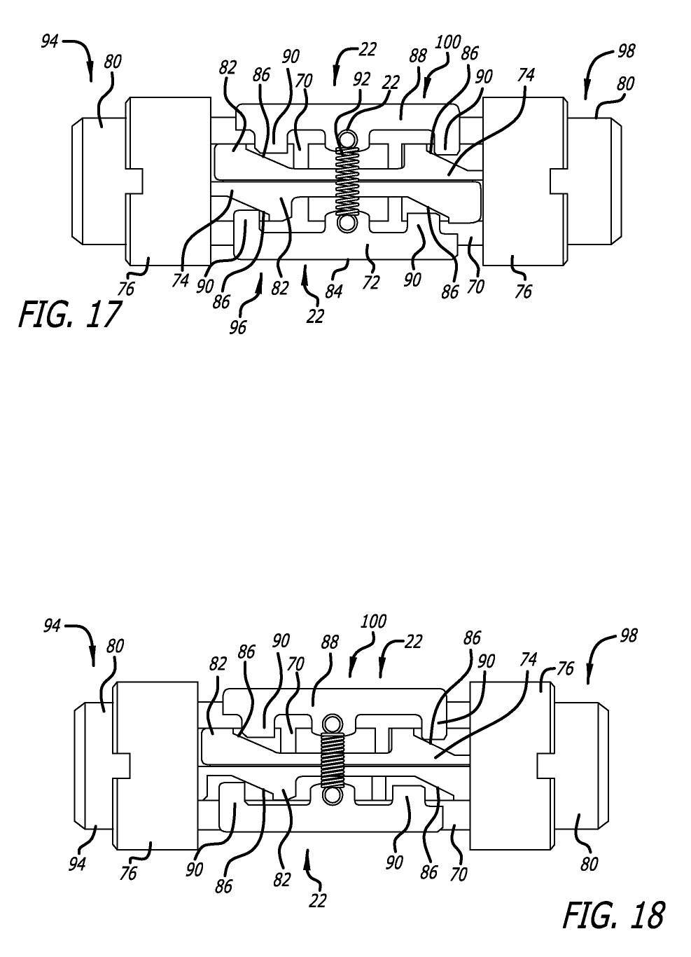

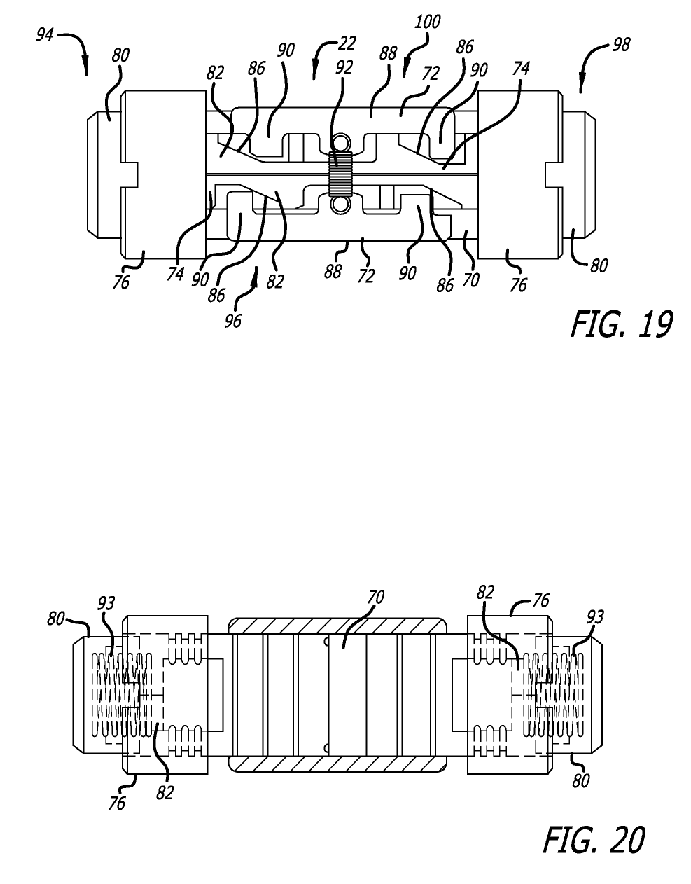

With reference now to FIGS. 17-20, one embodiment of a dual locking system 22 is shown. The locking system 22 includes a barrel 70 supporting other components of the system. The barrel 70 includes support structure providing spaces guiding movement of a pair of locking members 72 as well as structure defining button assemblies 74. Further guidance of the button assemblies 74 is provided by collars 76.

As best seen in FIGS. 17-19, the button assemblies 74 include a button pad 80 having a stem 82 projecting therefrom. In its assembled form, the stem 82 of the button assembly 74 projects away from the button pad 80 to which it is connected and toward the other button pad 80. Lengths of the one stem lie adjacent the stem of a second button assembly 74. The stem 82 further includes a plurality of ramped surfaces 86 which are configured to engage complementary structure of the locking members 72. So configured, the button assemblies 74 and more particularly, the stem 86 thereof can slide laterally with respect to the barrel 70 and in opposite directions with respect to each other.

The locking members 72 in turn include a first surface 88 configured to be received within recesses of tools such as those depicted in FIGS. 15 and 16 to thereby lock tool blades in open and closed position. Four or more such recesses can be provided to lock the blade in multiple positions. Moreover, an underside of the locking members 72 include a pair of spaced projections 90 sized and shaped to engage the ramps 86 formed on the button assembly stem 82. An extension spring 92 is further provided to bias the locking members 72 against the button assembly stem 86. Springs 93 are also provided to bias the button assemblies 74 outwardly. (See FIG. 20)

FIG. 17 depicts a dual lock system 22 in a locked configuration. To begin to unlock a tool blade, a first button pad 94 can be depressed as shown in FIG. 18. This results in the lateral translation of the stem 82 attached to the first button pad 94. Such action permits the projection 70 of a first locking member 96 to slide along the ramped surface 86 of the stem 82 in a controlled manner. Due to the angle of the ramped surfaces, the spring 92 is then allowed to withdraw the first locking member 96 inwardly and out of a recess (not shown) of a tool blade. Next, to complete the unlocking process, a second button pad 98 is depressed to thereby facilitate similar motion between the stem ramped surfaces of the second button assembly 80 and the projection 90 of a second locking member 100. The spring 92 is then again permitted to withdraw the second locking member 100 inwardly and out of a locking recess of a tool blade. Thus, the subject tool blade can be rotated from a locked to an unlocked position. Thereafter, the tool blade can be locked again as desired by registering the locking members in a different or the same set of tool blade recesses.

It is to be appreciated that the dual locking system can be employed in various applications relating to multi-function tools or other devices where enhanced control is desirable.

Thus, it will be apparent from the foregoing that, while particular forms of the invention have been illustrated and described, various modifications can be made without departing from the spirit and scope of the invention.

What is claimed:

1. A multi-function tool, comprising:
a first handle;
a second handle;
a first plier half rotatably attached to the first handle;
a second plier half rotatably attached to the second handle;
a plurality of tool blades rotatably configured in one or both of the first and second handles;
a dual lock system attached to one or both handles, the dual lock system including a plurality of actuators configured to lock and unlock at least one tool blade of the plurality of tool blades.

2. The tool of claim 1, the dual lock system further comprising first and second button assemblies.

3. The tool of claim 2, the dual lock system further comprising a first locking member operatively associated with the first button assembly.

4. The tool of claim 3, the dual locking system further comprising a second locking member operatively associated with the second button assembly.

5. The tool of claim 4, the dual lock system further comprising a spring, wherein the spring biases the locking members towards a withdrawn configuration.

6. The tool of claim 5, wherein the first and second button assemblies each include a stem configured with ramped surfaces.

7. The tool of claim 6, wherein the ramped surfaces engage one of the first and second locking members.

8. The tool of claim 7, wherein at least one locking member includes a pair of projections and the stem is configured with a pair of ramped surfaces, one ramped surface for each projection.

9. The tool of claim 8, wherein the stem is configured to slide laterally with respect to at least one of the first and second locking members.

10. The tool of claim 9, wherein sliding action of the stem causes the locking members to move from a locking position to an unlocked position.

11. The tool of claim 10, wherein at least one of the plurality of tool blades includes a pair of recesses, each recess being sized to accept one locking member.

12. The tool of claim 11, wherein both the first and second button assemblies are required to be depressed to unlock a tool blade.

13. The tool of claim 12, wherein the button assemblies are biased to an undepressed configuration.

14. A dual lock system for a tool, comprising:
a plurality of button assemblies; and
a locking member operatively associated with each of the plurality of button assemblies;
wherein actuation of each button assembly is required to unlock a tool.

15. The dual locking system of claim 14, further comprising a spring biasing the locking member toward a withdrawn configuration.

16. The dual locking system of claim 15, wherein each button assembly includes a stem configured with ramped surfaces.

17. The dual locking system of claim 16, wherein the ramped surfaces engage the locking member.

18. The dual locking system of claim 17, wherein the locking member includes a pair of projections and the stem is configured with a pair of ramped surfaces, one ramped surface for each projection.

19. The dual locking system of claim 18, wherein sliding action of the stem causes the locking member to move from a locking position to an unlocking position.

20. The dual locking system of claim 19, wherein the button assemblies are biased to an undepressed condition.
